(19) United States
(12) Patent Application Publication
(10) Pub. No.: US 2008/0240021 A1
(43) Pub. Date: Oct. 2, 2008

(54) MAC coordination architecture for multi-ratio coexistence and a method for connecting over sideband channels

(76) Inventors: Xingang Guo, Portland, OR (US); Changwen Liu, Portland, OR (US); Srikant Kuppa, Richfiled, OH (US); Hsin-Yuo Liu, San Jose, CA (US); Niklas Linkewitsch, Evessen (DE); Reed D. Vilhauer, Portland, OR (US)

Correspondence Address: INTEL CORPORATION;c/o INTELLEVATE, LLC, P.O. BOX 52050, MINNEAPOLIS, MN, 55402, US

(21) Appl. No.: 11/731,540

(22) Filed: Mar. 29, 2007

(51) Int. Cl. H04Q 7/00

(52) U.S. Cl. 370/328

(57) ABSTRACT

A wireless device with a multi-radio platform includes a scheduling coordinator connected by a control bus to enable the radios to share frequency spectrum by operating during time slots requested by the radios, avoid collisions, mitigate interference and control shared hardware components.

Technological developments permit digitization and compression of large amounts of voice, video, imaging, and data information. Evolving applications have greatly increased the transfer of large amounts of data from one device to another or across a network to another system. Computers have faster central processing units and substantially increased memory capabilities to handle this transfer of data.

To transfer this information between mobile, desktop or handheld devices potentially involves the simultaneous operation of two or more wireless access channels in the same frequency band and result in interference problems. Improved circuits and methods are needed for operating radios to mitigate interference problems.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a block diagram that illustrates a multi-radio platform wireless device that includes a scheduling coordinator connected by a control bus to enable the radios in accordance with the present invention;

FIGS. 2 and 3 are timing diagrams that illustrate a reservation process for the MAC coordinator and the radios;

FIG. 4 is a flow diagram of the reservation process and the MAC coordinator enabling and controlling the radio devices; and

FIGS. 5 and 6 illustrate embodiments of the control bus connecting the MAC coordinator to the multiple radios.

It will be appreciated that for simplicity and clarity of illustration, elements illustrated in the figures have not necessarily been drawn to scale. For example, the dimensions of some of the elements may be exaggerated relative to other elements for clarity. Further, where considered appropriate, reference numerals have been repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

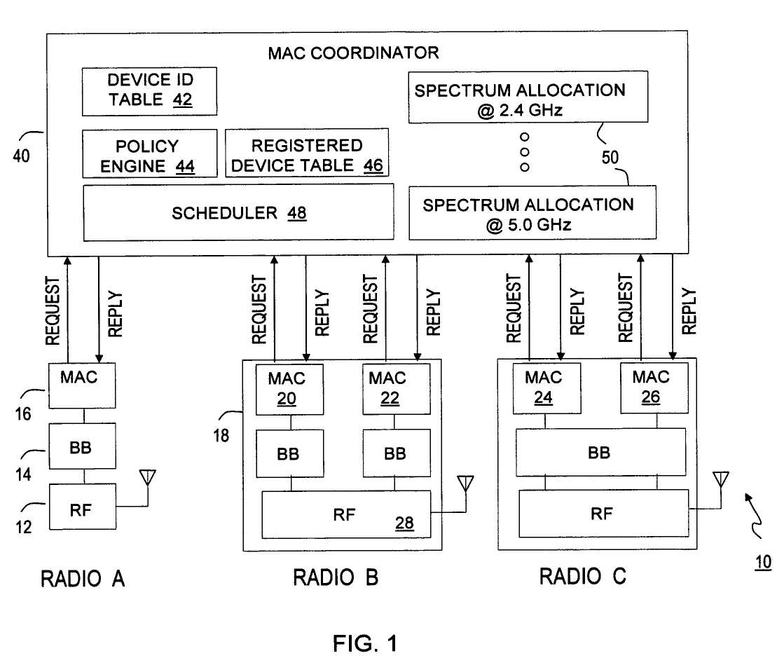

The embodiment illustrated in FIG. 1 shows a wireless communications device 10 that includes multiple radios to allow communication with other over-the-air communication devices. Communications device 10 may operate in wireless networks such as, for example, Wireless Fidelity (Wi-Fi) that provides the underlying technology of Wireless Local Area Network (WLAN) based on the IEEE 802.11 specifications; WiMax and Mobile WiMax based on IEEE 802.16; Wireless Personal Area Networks (WPANs) in IEEE 802.15 that permit communication within a short range; Bluetooth™ that uses a short-range radio link (up to 10 meters); and Ultra-Wideband (UWB) in IEEE 802.15.3a that is an emerging technology that provides a high rate WPAN, although the present invention is not limited to operate in only these networks.

The simplistic embodiment illustrates the coupling of antenna(s) to the transceivers to accommodate modulation/demodulation. In a discrete architecture, a radio device includes a dedicated Radio Front End (RFE) 12, a baseband processor 14 and a medium access control (MAC) 16. As such, the analog front end transceiver 12 may be a stand-alone Radio Frequency (RF) discrete that is connected to a processor 14 that fetches instructions, generates decodes, manages operands and performs appropriate actions, then stores results. Processor 14 may include baseband and applications processing functions and utilize one or more processor cores to handle application functions and allow processing workloads to be shared across the cores.

The embodiment also illustrates multiple radio subsystems collocated in the same platform of communications device 10 to provide the capability of communicating in an RF/location space with other devices. The combo architecture 18 illustrates a baseband processor in combination with a MAC 20 and another baseband processor in combination with MAC 22 that share a common RF front end 28. By embedding a baseband processor and a MAC, resource sharing of RF front end 28 provides a cost reduction. To mitigate interference between the received signals, a coordination mechanism coordinates the operation of RADIO A, RADIO B, and RADIO C to control hardware components and share frequency spectrum. In accordance with embodiments of the present invention, the architecture includes a MAC coordinator 40 that provides coordination at the medium access control (MAC) layer to enable and control simultaneous operations for multi-Radio Coexistence.

Again, the figure illustrates a Radio A with a discrete architecture whereas radios B and C illustrate combo architectures. Note that the MAC blocks 20 and 22 in Radio B share the same RFE but have separate baseband processors, while in Radio C the MAC blocks 24 and 26 share the same baseband processor and the same RFE. FIG. 1 also shows conditions where possible collisions between radios may occur. By way of example, MAC block 16 may process signals received in Radio A and share the same or adjacent spectrum as MAC block 20 that processes signals received in Radio B. Further collision possibilities are illustrated in Radio B where MAC blocks 20 and 22 share the same RFE and based on the spectrum, MAC block 22 may process signals that provide interference with signals being processed in MAC block 24. Yet further resource collision possibilities are illustrated in Radio C where MAC blocks 24 and 26 share the same RFE and the same baseband processor.

Prior art 802.11 networks have used Request to Send (RTS) and Clear To Send frame (CTS) to maintain throughput when the number of stations increase and to reduce the number of packet collisions in what is called the “hidden terminal” problem. With RTS/CTS, the sending node initiates the process by sending a RTS frame and the destination node replies with a CTS frame. These prior art techniques that use the RTS/CTS reservation scheme may regulate traffic to accommodate traffic load growth and reduce collisions in data packet transmissions.

However, MAC coordination 40 enables and controls radio devices in a platform using a technique that is different from the RTS/CTS reservation scheme. MAC coordination 40, in accordance with embodiments of the present invention, enables and controls radio devices by interleaving atomic operations for the multiple radios over the time domain. Note that the phrase “atomic operation” is defined as an uninterrupted sequence of transmitting or receiving operations by a MAC protocol. Examples of “atomic operations” may include, but are not limited to, the sequence of RTS-CTS-DATA-ACK in 802.11 and the header, downlink and uplink portions of a super frame in 802.16e. Radio A, Radio B and Radio C may request from MAC coordinator 40 a time slice or a reservation to be reserved for that radio. During the reserved time slice the selected radio performs an atomic operation(s) without other radio devices within the same platform being active.

Thus, MAC coordinator 40 resolves contentions among the radios in the platform to ensure that the multiple radios may operate in overlapping or adjacent frequency bands without interference and collisions. MAC coordinator 40 may also resolve contentions among radios that share components such as for example, sharing the RFE or sharing a baseband processor, etc. Again, a radio requests that MAC coordinator 40 schedule and reserve interleaved time slices during which the selected radio is active while the other radios in communications device 10 are inhibited from being active.

MAC coordinator 40 resolves contentions amongst the radios in the platform using the interactions of a Device ID Table 42, a Policy Engine 44, a Registered Device Table 46, a Scheduler 48 and Spectrum Allocation tables 50 as shown in FIG. 1. Policy engine 44 stores and enforces a set of predefined or platform-specific safe operating conditions. A list of the current rules that regulate the platform-specific safe operating conditions are stored and maintained in the Registered Device Table 46. By way of example, the safe operating conditions may stipulate that if two or more MACs share the same hardware component(s) that concurrent transmit and/or receive operations are not permitted. By way of another example, the safe operating conditions may stipulate that two MACs in different radios may concurrently operate (transmit or receive) in adjacent spectrum frequency based on approved parameters such as transmission power, receiver sensitivity, antenna isolation, the presence or absence of a filter in the receiver circuitry, etc. Thus, policy engine 44 stores and enforces a rule set that determines whether multiple radio devices may operate simultaneously.

MAC coordinator 40 uses the Registered Device Table 46 to locally assign unique device identifiers at the time of registering the MAC entity of a radio device to overcome the 48-bit MAC address overhead. Thus, each entry in Device ID Table 42 includes the 48-bit MAC address of the radio device sending a registration request to the MAC coordinator 40 and also includes the Device ID which is the identifier assigned by the coordinator. Functionally, Device ID Table 42 serves as a mapping translator between the 48-bit MAC address and the assigned Device ID. After device registration, the radio may communicate with the MAC coordinator 40 using the previously assigned Device ID.

Registered Device Table 46 stores static information provided by the radio device. In addition to the identifier assigned by the coordinator, entries in Registered Device Table 46 may include information about the type of the reservation for the registered service; a central frequency of operation for a radio device; a frequency band range for a radio device; a transmission power of the radio device, a receiver sensitivity of the radio device; and a receiver saturation of the radio device, among other parameters and characteristics. It should be noted that these examples are provided as examples of information that may be stored in Registered Device Table 46 but the table is not limited and other types of information may be stored.

MAC coordinator 40 also maintains a spectrum allocation table per collision domain, where a collision domain refers to the set of devices sharing a spectrum and/or sharing a hardware component(s). One spectrum allocation table 50 may be maintained for 802.11 b/g and 802.16 radio devices which operate in the 2.4 GHz band while another spectrum allocation table 50 may be maintained for UWB, 802.16e and 802.11a devices in the 5 GHz band. Yet another spectrum allocation table 50 may be maintained for 802.11 and 802.16 devices built on a combo card. By way of example, the spectrum allocation tables may include, among other things, the identity of the radio device which requested the reservation; a start time that is the time at which the reserved atomic operation starts; an end time that is the time at which the reserved atomic operation ends; and a priority of the reservation (set by consulting policy engine) to resolve future conflicts. Scheduler 48 is responsible for communicating with the different radio devices and keeping the spectrum allocation tables 50 up to date.

In one example embodiment that describes the reservation policy, a control frame having a low priority after successive failure attempts to transmit the frame may be changed to a high priority. By way of another example embodiment, a low priority atomic operation during a beacon period may be changed to a high priority atomic operation if the radio device is denied participation during the beacon period by the coordinator for a number of consecutive times. For data frames, a voice frame may be classified as high priority data and a best-effort frame may be classified as low priority data. Thus, MAC coordination provides a set of methods to avoid conflicts by providing one radio a higher priority than the other radios and reserving commonly shared resources for use by the radio having priority.

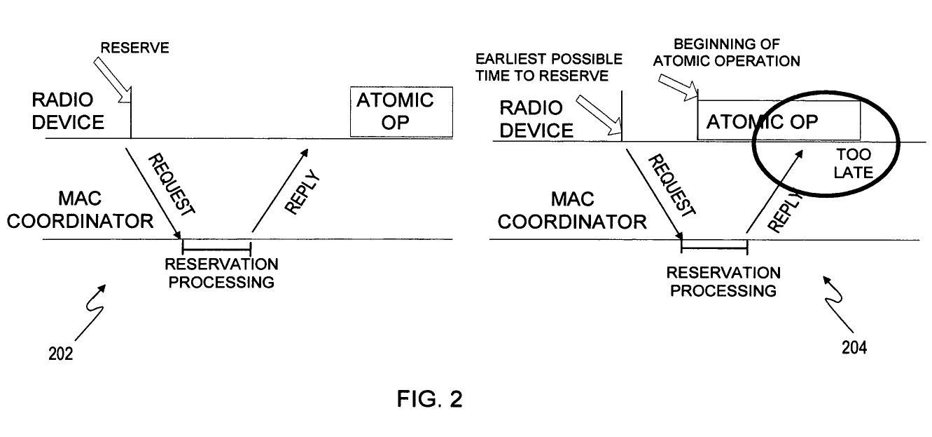

MAC coordinator 40 supports two types of coordination mechanisms, namely, an on-demand mechanism and a push mechanism. FIG. 2 illustrates the on-demand mechanism by showing the initiation of a reservation request from an individual radio device prior to performing an atomic operation which is then followed by the receipt of grant/reject from MAC coordinator 40. If MAC coordinator 40 grants the reservation request then the radio device performs the atomic operation as denoted by reference number 202. Also illustrated in the figure is a request by a radio device for a reservation but the grant decision is late and received after the start time of the atomic operation, and therefore, the radio device is not able to obey the decision (grant/reject) made by the coordinator. In other words, if the reply is not received before the start time of the atomic operation, then the radio device does not perform that operation as denoted by reference number 204.

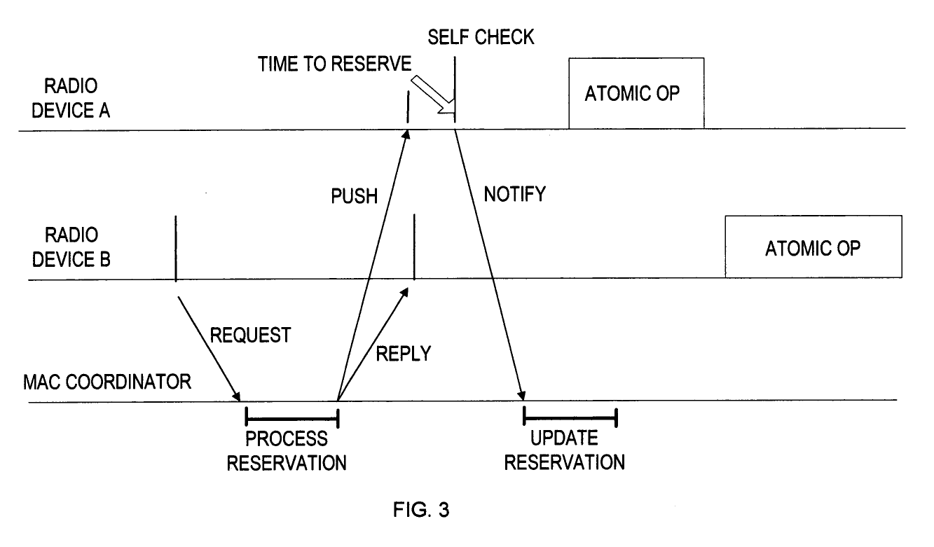

Using a PUSH protocol, MAC coordinator 40 informs the radio devices of the time at which their usage of the spectrum should cease. By providing this time information to the radio devices, the time slices requested by the radio devices to transmit may be allocated and strictly enforced so that collisions between the radios may be avoided. However, until the advertised time instant, the spectrum is available for use and the radio devices may use that spectrum for their atomic operations, if any. If one of the informed radio devices identifies that it can perform an atomic operation prior to the advertised time instant, then it may make an autonomous reservation and send a postpartum update/notify. FIG. 3 illustrates that one of the informed radio devices such as RADIO A, for example, identifies that it can perform an atomic operation prior to an advertised time instant that was derived by RADIO B and MAC coordinator 40 is notified to updates its reservation table.

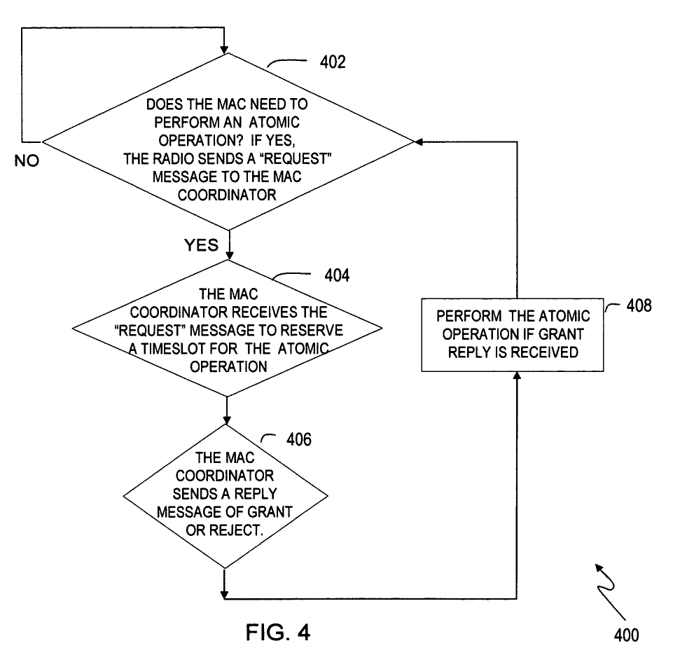

FIG. 4 shows a flowchart in accordance with various embodiments of the present invention that illustrates an algorithm or process that may be used to schedule and control behavior for multiple radios in a communications device 10. Method 400 or portions thereof are performed by the radio device in combination with MAC coordinator 40. Method 400 is not limited by the particular type of apparatus, software element, or system performing the method. Also, the various actions in method 400 may be performed in the order presented, or may be performed in a different order.

In method 400 a decision is made as to whether the MAC (represented by MAC 16, MACs 20 and 22, and MACs 24 and 26 in FIG. 1) needs to perform an atomic operation (see block 402). The MAC sends a request message to the MAC coordinator 40. MAC coordinator 40 receives the request for a reservation as indicated in block 404. In block 406 the MAC coordinator 40 sends a reply message that may be either a grant message or a reject message. If MAC coordinator 40 reserves a time slot for the atomic operation then the grant message received by the MAC allows the atomic operation to be performed during the reserved time slice (see block 408). However, if the reservation is not granted, then the reject message sent to the MAC disallows the atomic operation.

Thus, a radio in communications device 10 sends a “request” message and the MAC coordinator 40 receives the “request” message. MAC coordinator 40 consults the Policy Engine 44 to determine whether to grant or reject the reservation request. If granted, the scheduler component 48 reserves a time slice or time slot during which the atomic operations may be scheduled to be performed. The booking will be active from that time on and no other radio may use the time slot or use a resource that is common or shared with other radios. The booking will be removed from the allocation table.

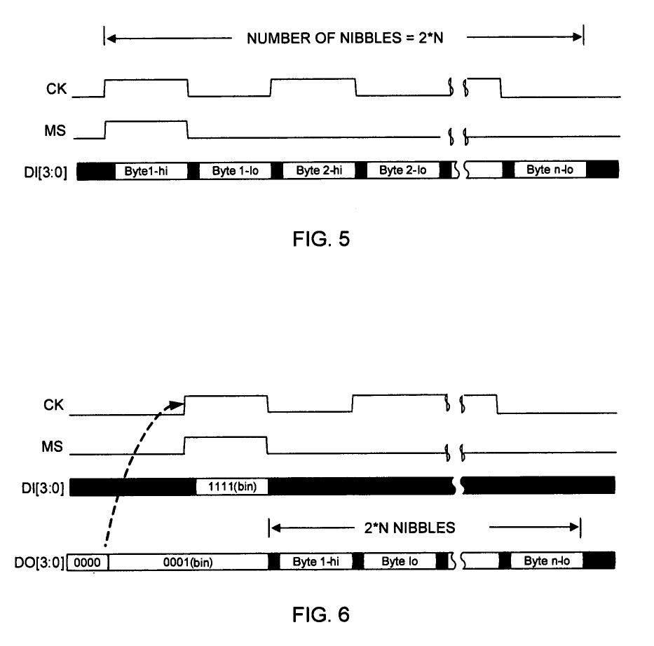

FIGS. 5 and 6 illustrate embodiments of sideband signals used by the various radios in communications device 10 as a communications interface with MAC coordinator 40. The “N” discrete radios may operate simultaneously by using the communications interface to ensure that radio transmissions and receptions are coordinated at the MAC level to avoid collisions. MAC coordination also controls the activity of the radios that may share a common RF front end such as, for example, the WiFi/WiMax combo card. Also, the MAC coordination allows transmissions and receptions from the different baseband units that share common radio circuitry.

The figures show that “REQUEST” and “REPLY” operations and all other MAC coordination messages may be coded in a string of “N” bytes that is transmitted using the sideband signals over the control bus. As shown in the figures, the control bus provides signal paths for a clock signal CK, a Message Start signal MS, a 4-bit Data Input bus (DI) that provides directional signals from the radio to the MAC coordinator 40, and another 4-bit directional Data Output bus (DO) from the MAC coordinator 40 to the radios.

In operation, when one radio plans to send or receive data using a wireless channel it will request a timeslot from the MAC coordinator 40 via the sideband interface. The MAC coordinator 40 processes the request by looking up its integrated allocation table. Depending on the current existing allocations, MAC coordinator 40 either grants or rejects the requested booking by sending back a “reply” via the same sideband interface. In case of a “grant”, the corresponding booking is added to the allocation table. For a radio having a high priority, the “reply” may not be necessary because a “grant” is assumed based on the priority status. In other applications, the MAC coordinator 40 takes the initiative to inform the multiple radios about currently available free timeslots.

By now it should be apparent that embodiments of the present invention allow a better quality of service and a higher data rate when two radios are operating in the same platform. The present invention permits real time radio packet coordination and reduces the likelihood of a packet loss and reduces packet re-transmission. The addition of a MAC coordinator to control radio activity in a multi-radio platform also maintains network connectivity by ensuring that radio devices participate in beaconing/signaling period. The present invention permits radio activity to be scheduled under multiple operating constraints even though radio devices may operate in overlapping or adjacent bands and/or share components. Embodiments of the present invention minimize radio interference and maximize bandwidth usage.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1. A device comprising:
first and second radios in a multi-radio platform; and
a scheduling coordinator coupled to the first and second radios to enable the first and second radios to operate during time slots requested by the first and second radios.

2. The device of claim 1 wherein the scheduling coordinator provides central control over the first and second radios through a bus to receive a request message from one of the first and second radios and provide a grant message or a reject message through the bus.

3. The device of claim 1 wherein the scheduling coordinator includes:
a policy engine to store a set of platform-specific operating conditions to determine whether to grant or reject the reservation request.

4. The device of claim 1 wherein the scheduling coordinator includes:
a scheduler to reserve a time slot during which operations may be scheduled to be performed.

5. The device of claim 1 wherein the scheduling coordinator includes:
a first spectrum allocation block maintained for radio devices which operate in the 2.4 GHz band; and
a second spectrum allocation block maintained for radio devices which operate in the 5 GHz band, wherein the first and second spectrum allocation tables include an identity of the radio device which requested the reservation.

6. The device of claim 5 wherein the first and second spectrum allocation tables further include a start time that is the time at which the reserved operation starts and an end time that is the time at which the reserved operation ends.

7. The device of claim 5 wherein the first and second spectrum allocation tables further include a priority of the reservation to resolve conflicts with the first and second radios.

8. A multi-radio platform comprising:
first and second radios;
a scheduling coordinator; and
a bus interface to transfer a request message from the first radio to the scheduling coordinator to grant the first radio a time slot and a grant message from the scheduling coordinator to the first radio to coordinate radio transmissions and receptions by the first radio with the second radio.

9. The multi-radio platform of claim 8 wherein the bus interface couples the first radio and the second radio to the scheduling coordinator to avoid collisions with radio transmissions and receptions of the first and second radios.

10. The multi-radio platform of claim 8 wherein the bus interface transfers a string of coded bytes over a control bus.

11. The multi-radio platform of claim 8 wherein the control bus includes a 4-bit data bus that provides signals from the first and second radios to the scheduling coordinator and another 4-bit data bus that provides signals from the scheduling coordinator to the first and second radios.

12. The multi-radio platform of claim 8 wherein the scheduling coordinator controls activity of an RF front end shared by the first and second radios.

13. The multi-radio platform of claim 8 wherein the scheduling coordinator controls activity of first and second baseband units that share common radio circuitry.

14. A method for a multi-radio platform comprising:
issuing a request message by a first radio via a control bus to a central scheduling coordinator to reserve a time slot to perform an operation;
reserving the time slot by the central scheduling coordinator for the first radio and responding via the control bus with a grant message; and
performing the operation by the first radio in the time slot when the grant message is received.

15. The method of claim 14 further including:
storing a set of platform-specific operating conditions used by a policy engine to determine whether to grant the request message issued to the central scheduling coordinator.

16. The method of claim 14 further including:
using a first spectrum allocation block maintained for radio devices which operate in the 2.4 GHz band; and
using a second spectrum allocation block maintained for radio devices which operate in the 5 GHz band, wherein the first and second spectrum allocation tables include an identity of the first radio.

17. A method of using a push protocol for a multi-radio platform comprising:
using a MAC coordinator to notify a first radio device that registered a push protocol that a second radio device has made a reservation; and
pushing information to the first radio device who registered the push protocol that includes information about time slices reserved for the second radio device.

18. The method of claim 17 wherein the first radio device uses the information about time slices reserved for the second radio device that includes:
knowing when spectrum and resources are occupied in deciding to perform an operation.

19. The method of claim 18 wherein the first radio device uses the information about time slices reserved for the second radio device that includes:
notifying the MAC coordinator with the time slices that it is using the spectrum.

20. The method of claim 17 further comprising:
updating a reservation table by the MAC coordinator after receiving the notify from the first radio device.
